(19) United States
(12) Patent Application Publication
(10) Pub. No.: US 2022/0266271 A1
(43) Pub. Date: Aug. 25, 2022

(54) GUN CONTAINING HANGER WITH LIGHTING FUNCTION FOR POWDER COATING APPLICATIONS

(71) Applicant: Sistem Teknik Makina Sanayi Ve Ticaret Anonim Sirketi, Izmir (TR)

(72) Inventors: Serdar KAYA, Izmir (TR); Deniz TURKUN, Izmir (TR); Mert DEMIRTAS, Izmir (TR)

(21) Appl. No.: 17/635,890

(22) PCT Filed: Jul. 8, 2021
(86) PCT No.: PCT/TR2021/050705

§ 371 Date: Feb. 16, 2022

(30) Foreign Application Priority Data
Aug. 20, 2020 (TR) 2020/13156

(51) Int. Cl. B05B 5/053

(52) U.S. Cl. CPC B05B 5/053

(57) ABSTRACT

A powder coating gun with lighting function which is used in the powder coating industry in areas where manual application will be performed and contains a gun body, a gun handle, a gun trigger, a gun nozzle set, a union nut, and an electrostatic generator, further having a gun hanger with lighting source with a light source providing the illumination, a lens providing the focusing and an electrical cable providing the connection to a control unit.

### FIELD OF THE INVENTION

The present invention relates to a powder coating gun with lighting function and a gun hanger with lighting function, used in the powder coating industry, in areas where applications will be carried out manually.

### STATE OF THE ART

Today, manual electrostatic powder coating guns are used for the powder coating of workpieces. The powder coating gun loads the coating material with an electrostatic charge and provides its adherence to the grounded area by spraying the same.

The main aspect of the electrostatic powder coating process is the coating of the material by adhering the negatively charged coating powder particles to the grounded surface to be coated. The coating powders that move with compressed air inside the gun are passed through an electric field while it exits the nozzle set of the gun, and are charged electrically by means of the electrostatic generator inside the gun body and/or the friction method. Negative ionizing particles are sprayed onto the grounded (uncharged) material to coat the surface.

Today, electrostatic powder coating is one of the most efficient coating methods. The main aspects of this are as follows; it can reach thinner film thicknesses compared to other methods, and the reuse of the sprayed powder coatings with recovery methods. Furthermore, while the powder coating particles exiting the gun easily adhere to the surface to be coated, they do not contact with each other since they have the same charge. This ensures a uniform and homogenous coating.

Although this method can be achieved with coating robots in automated systems, it is difficult to achieve the same homogeneity in manual applications. Particularly, in parts with complex geometry, the operator must observe the coating area well (it must be illuminated). The force applied to the wrist of the operator holding the gun manually makes the operator tired due to the weight of the gun in powder coating applications. Therefore, the weight of the powder coating gun shall be as low as possible.

In the state of the art, a device that is attached on to the gun and contains batteries and electronic equipment has been suggested. However, it has been observed that this device does not solve technical problem regarding the weight of the gun, on the contrary, it makes the powder coating gun heavier.

It has been observed that light sources are attached to the powder coating guns in various ways in previous studies. However, although these models illuminate the area to be coated, they increase the weight of the gun due to the further equipment attached to the gun. For example, in patent application numbered U.S. Pat. No. 10,539,318 B2, it is seen that a lighting apparatus is placed on the upper part of the body of the powder coating gun. The attached apparatus does not have a function that will contribute to the use of the gun other than lighting function. This apparatus, which contains at least one battery and electronic components, increases the weight of the gun and negatively affects the powder coating application. Furthermore, since this apparatus attached to the gun body is positioned very close to the gun body in the upper-rear region of the gun, the shadow of the gun body forms an unilluminated area on the workpiece. For this reason, it is seen that the present invention is not a solution to the technical problem of the requirement of a lightweight gun and to the technical problem of lighting without creating shadows on the workpiece.

Furthermore, in the patent study numbered U.S. Pat. No. 10,539,318 B2, since the lighting apparatus is positioned in the usage area of the gun hanger, it reduces the function of the gun hanger and makes it difficult to hang the gun.

Besides, although the patent applications U.S. Pat. Nos. 4,912,750 and 3,784,804 are not related to powder coating guns, it is seen that the light sources are placed in the front of the gun. The attached lighting does not have a function that will contribute to the use of the gun other than lighting function. In these and similar positioning, although the problem of creating shadows on the surface to be coated is eliminated, the center of gravity of the gun moves away from the operator's wrist and further parts are attached outside the center of gravity. As a result, the force that forces the wrist of the operator to rotate increases and fatigues the operator.

As a result, due to the abovementioned disadvantages and the insufficiency of the current solutions regarding the subject matter, a development is required to be made in the relevant technical field.

### AIM OF THE INVENTION

The invention aims to provide a structure having different technical features which brings a new development in this field different from the embodiments used in the state of the art.

The main aim of the invention is to provide a powder coating gun containing a light source that illuminates the powder sprayed area so as to ensure that the operator using the powder coating gun can detect the area to be coated well.

The aim of the invention is to position the light source on the hanger apparatus on the top of the gun in a manner such that it is integrated with the gun, without adding additional weight to the gun so as to illuminate the workpiece with the highest efficiency and so as not to make the gun heavier and not to affect the operator's use negatively.

Another aim of the invention is to provide a structure that enables the gun to perform the function of lighting without becoming heavy. Instead of placing the light source in the gun hanger with a lighting function, not using an extra carrier apparatus and placing electronic components inside the powder coating gun to adjust the light level, together with the invention it is provided to perform this operation from the control unit and to make the electrostatic powder coating gun to remain lightweight.

Placing the light source in the gun hanger with the lighting function has also been a solution to the problem of hanging the spray gun on the gun hanging hook with the invention.

In order to fulfil the above-mentioned aims, the invention is a powder coating gun with lighting function which is used in the powder coating industry in areas where manual application will be performed and contains gun body, gun handle, gun trigger, gun nozzle set, union nut, and electrostatic generator, characterized by comprising; a gun hanger with lighting function comprising the following;
Light source that provides illumination,
Lens that provides focusing,
Electrical cable that provides connection to the control unit.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1.1 is a perspective view of the inventive gun.

FIG. 1.2 is a rear view of the inventive gun.

FIG. 1.3 is a side view of the inventive gun.

FIG. 1.4 is a detailed view of the lighting configuration of the inventive gun.

FIG. 2.1 is a side view of the use of the inventive gun.

FIG. 2.2 is an illustrative view of the environment where the inventive gun is used.

FIG. 3, is an illustrative view of the relation of the inventive gun and the control unit.

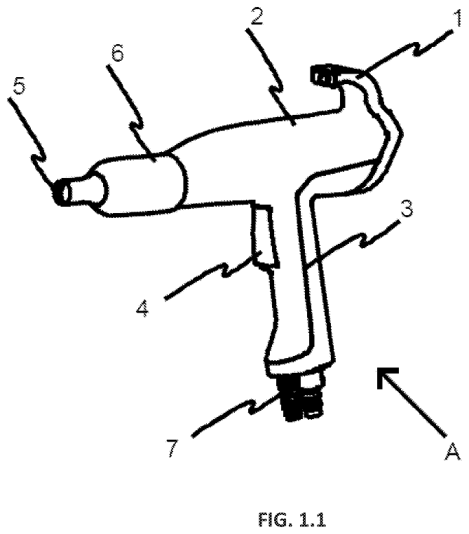

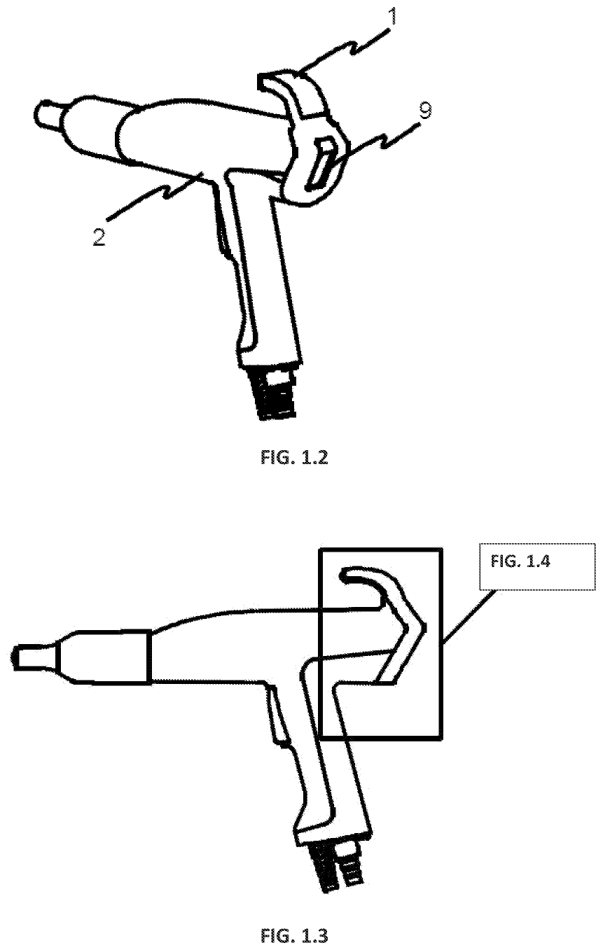

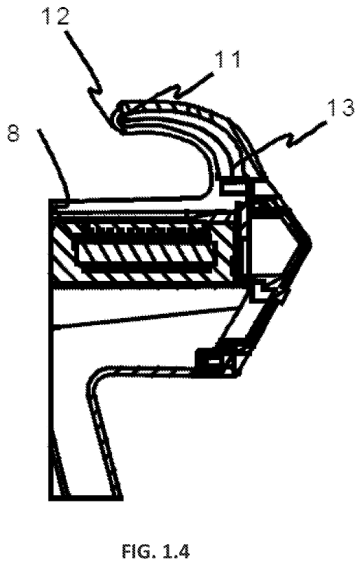

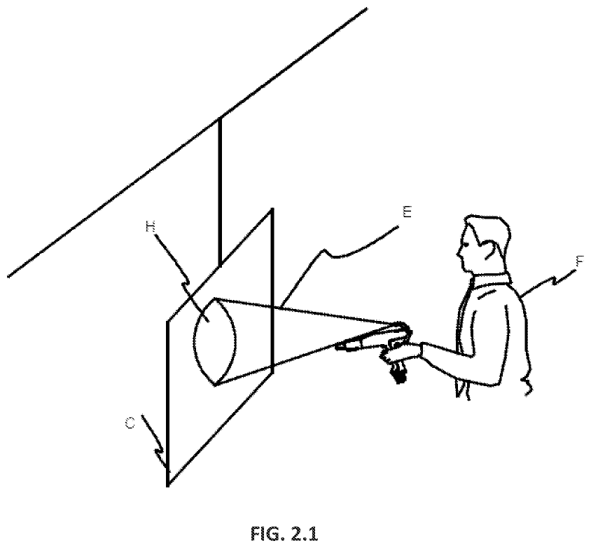

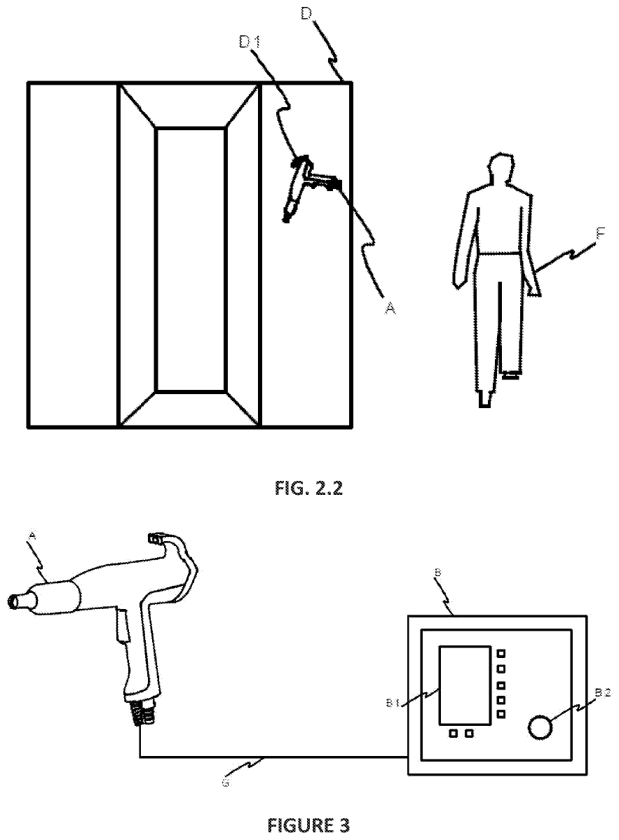

The figures are not required to be scaled and the details which are not necessary for understanding the present invention may be neglected. Moreover, the elements that are at least substantially identical or have at least substantially identical functions are shown by the same number.

### DESCRIPTION OF THE PART REFERENCES

A. Powder coating gun

B. Control unit

B1. Control unit display panel

B2. Control unit adjusting button

C. Workpiece

D. Cabin and similar application equipment

D1. Gun hanging hook

E. Light beam

F. Operator

G. Gun power connection

Lighting zone

1. Gun hanger with lighting function

11. Light source

12. Lens

13. Light source power cable

2. Gun body

3. Gun handle

4. Gun trigger

5. Gun nozzle set

6. Union nut

7. Gun power cable

8. Electrostatic generator

9. User interface

### DETAILED DESCRIPTION OF THE INVENTION

In this detailed description, the preferred embodiments of the invention are described only for clarifying the subject matter in a manner such that no limiting effect is created.

The present invention relates to a powder coating gun with lighting function (A) and a gun hanger with lighting function (1), used in the powder coating industry, in areas where applications will be carried out manually.

The workpiece (C) should be illuminated so as to ensure the operator (F) to better see the area to be coated. The problem of shadow formation on the workpiece (C) caused by the closeness of the light source (11) to the body in the state of the art is solved with the inventive structure by positioning the light source (11) on the gun hanger with lighting function (1) away from the gun body (2).

The inventive electrostatic powder coating gun with lighting function (A) mainly comprises gun hanger with lighting function (1), gun body (2), gun handle (3), gun trigger (4), gun nozzle set (5), union nut (6), electrostatic generator (8), and user interface (9).

The said gun hanger with lighting function (1) comprises light source (11), lens (12) that provides focusing and electric cable (13) that provides the connection to the control unit (B). Electrostatic powder coating gun (A) and light source (11) receive their electrical power from a control unit (B) to which they are connected. The said electrical cable (13) engages with the gun power cable (7) inside the electrostatic powder coating gun (A) and connects to the control unit (B) with the gun power connection (G).

The gun hanger with lighting function (1) is a part connected to the gun body (2), the illumination level is adjusted using and adjusting button (B2) on the control unit (B) if necessary and the control unit on the front of the illumination level control unit (B) can be seen on the display panel (B1).

The gun hanger with lighting function (1) ensures the protection of electrostatic powder coating gun (A) by hanging the same on the hanger hook (D1) on the booth and similar application equipment (D) where the application is made so as not to damage the gun surface and functional parts when application is not made.

The said light source (11) can be operated in various ways for different aims by using the gun trigger (4) and the user interface (9). The operating principle of the light source (11) is mainly as follows; while spraying with the electrostatic powder coating gun (A), a light beam (E) comes out from the gun hanger with lighting function (1) and the workpiece (C) is illuminated by forming an illumination zone (H) on the workpiece (C). The illumination process starts simultaneously with the spraying of the coating powder when the gun trigger (4) is pressed and ends when the gun trigger (4) is released and/or the light source (11) located in the gun hanger with lighting function (1) continues to illuminate the workpiece (C) for a while after the gun trigger (4) is released. In cases where the lighting function is desired to work continuously, illumination made by the light source (11) in the gun hanger with lighting function (1) starts when the button (9) on the user interface is pressed by the operator (F) and ends automatically after a while or it is terminated by the operator (F) by pressing the button (9) on the user interface.

1. A powder coating gun with a lighting function which is used in the powder coating industry in areas where manual application will be performed and contains a gun body, a gun handle, a gun trigger, a gun nozzle set, a union nut, and an electrostatic generator, characterized by comprising: a gun hanger with lighting function comprising the following;
a light source that provides illumination,
a lens that provides focusing, and
an electrical cable that provides connection to a control unit.

2. The powder coating gun with lighting function according to claim 1, wherein the control unit to which the electrical power of the powder coating gun and the light source is connected comprises the following:
an adjusting button which allows to control the illumination level of the light source, and
a display panel for displaying the illumination level.

3. The powder coating gun with lighting function according to claim 1, wherein the electrical cable is inside the powder coating gun, and which is connected to the gun power cable and connected to the control unit with the gun power connection.

4. The powder coating gun with lighting function according to claim 1, wherein the gun hanger with lighting function ensures the protection of electrostatic powder coating gun by hanging the same on the a hanger hook on the booth and similar application equipment where the application is made so as not to damage the gun surface and functional parts when application is not made.

5. Operating method of a powder coating gun with lighting function which is used in the powder coating industry in areas where manual application will be performed and contains a gun body, a gun handle, a gun trigger, a gun nozzle set, a union nut, and an electrostatic generator, the method comprising, the following process steps:
coming out of a light beam from a gun hanger with lighting function and illuminating the workpiece is by forming an illumination zone on the workpiece while spraying with the electrostatic powder coating gun,
initiation of an illumination process simultaneously with the spraying of the coating powder when the gun trigger is pressed and termination of the same when the gun trigger is released and/or continuing to illuminate the workpiece for a while after the gun trigger is released with the help of a light source located in the gun hanger with lighting function,
in cases where the lighting function is desired to work continuously, starting the illumination made by the light source in the gun hanger with lighting function when a button on a user interface is pressed by an operator and end automatically after a while or terminating the same by the operator by pressing the button on the user interface.
